(19) United States
(12) Patent Application Publication
(10) Pub. No.: US 2006/0234594 A1
(43) Pub. Date: Oct. 19, 2006

(54) Sealing material and image display device using sealing material

(76) Inventors: Akiyoshi Yamada, Fukaya-shi (JP); Hiromitsu Takeda, Kawasaki-shi (JP); Hirotaka Unno, Fukaya-shi (JP); Yuichi Shinba, Hiratsuka-shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 11/452,215

(22) Filed: Jun. 14, 2006

Related U.S. Application Data
(63) Continuation of application No. PCT/JP04/18584, filed on Dec. 13, 2004.

(30) Foreign Application Priority Data
Dec. 15, 2003 (JP) 2003-416457

(51) Int. Cl. H01J 9/26

(52) U.S. Cl. 445/25; 428/447; 445/24; 277/628

(57) ABSTRACT

A flat image display device includes two substrates located opposite each other with a gap therebetween and a vacuum seal portion which seals a predetermined position on the substrates and defines a sealed space. The vacuum seal portion has a sealing layer which is formed of a sealing material filled along the predetermined position. The sealing material having a melting point of 400° C. or less and a rate of contraction during solidification ranging from +0.5% to −2.5%.

### CROSS-REFERENCE TO RELATED APPLICATIONS

This is a Continuation Application of PCT Application No. PCT/JP2004/018584, filed Dec. 13, 2004, which was published under PCT Article 21(2) in Japanese.

This application is based upon and claims the benefit of priority from prior Japanese Patent Application No. 2003-416457, filed Dec. 15, 2003, the entire contents of which are incorporated herein by reference.

### BACKGROUND OF THE INVENTION

1. Field of the Invention

This invention relates to a sealing material used in a vacuum seal portion for maintaining a high-vacuum space between two substrates that constitute an image display device and a flat image display device using the same.

2. Description of the Related Art

A self-emissive flat panel display, which is recently becoming a mainstream display, basically comprises two glass substrates. A circuit for forming an image and electron emission or plasma formation elements are incorporated in one of the glass substrates, while a phosphor that faces these elements is formed on the other glass substrate. The two glass substrates are located opposite each other with an appropriate space between them such that the elements can behave effectively. A display of an electron-beam excitation type requires a high degree of vacuum of this space. Accordingly, the two glass substrates must secure an appropriate space between them and have a structure strong enough to withstand a high vacuum.

In order to form this structure, according to a technique disclosed in Jpn. Pat. Appln. KOKAI Publication No. 2002-319346, a frame body of the same material as glass substrates is prepared, and this frame body is bonded along the entire circumference of one of the glass substrates with a glass-based adhesive. The other glass substrate and the frame body are bonded together for vacuum sealing with use of a low-melting-point metal, such as indium or an indium alloy, which has wettability with glass. If the low-melting-point metal is heated to its melting point or higher temperature and melted, it ensures highly airtight sealing, owing to it its high wettability with glass.

However, small-area sealing is an object of the method in which the vacuum seal structure is obtained with use of a low-melting-point metal, such as indium or an indium alloy, as the sealing material. Since a large-sized image display device requires sealing of a very large elongated area, it is hard to obtain a high-reliability vacuum seal structure by simple application of the prior art technique.

Occurrence of shrinkage that is attributable to solidification contraction of the low-melting-point metal is one of major factors of the above problem. The contraction of the low-melting-point metal that consists mainly of indium exceeds 2.5% during solidification. In the small-area vacuum sealing, the contraction causes no problem, since the absolute amount of the sealing material is larger enough than the amount of contraction. In the large-sized image display device, however, the entire circumferential length of the seal portion is nearly 3 m. Even if vacuum sealing is performed with a liquid sealing material, therefore, the length of the seal portion is 75 mm shorter than required when the sealing material contracts as it solidifies. This contraction of the sealing material is not bound to occur in one place, and it can be compensated for by transverse contraction. However, the probability of a loss of the essential continuity for the maintenance of a vacuum is very high.

Conventionally, in a casting technique or a technique for molding a molten metal, contraction of the molten metal during solidification is compensated for by a method based on a system in which a surplus molten metal called a “riser” flows in molds. Although this system can be applied to vacuum sealing of a flat image display device, manufacturing processes for continuous molding in a vacuum must be made highly complicated. It is difficult, therefore, to establish this technique as an industrial mass-production technique.

Printing types of antimony are an example of products by a technique that manufactures high-precision castings without using the riser. This technique is based on the utilization of properties of antimony such that it, unlike other conventional metals, expands its volume as it solidifies and that it has a relatively low melting point. However, the low melting point and the applicability to image display devices involve a problem for the sealing material. Specifically, the melting point and the solidification contraction rate of antimony are 630.7° C. and −0.9% (minus sign indicates expansion during solidification), respectively. If any other metal is mixed into antimony to adjust the melting point of the sealing material to its desired value, 400° C. or less, the solidification contraction rate changes to a positive value. Further, the vapor pressure of antimony at 400° C. is very high, as high as 2.9×10⁻³ Pa. Accordingly, there is also a problem that antimony inevitably volatilizes if it is subjected to a high vacuum.

Thus, the prior art technique has a problem that high vacuum sealing properties cannot be maintained because the continuity of the seal portion is ruined by the contraction of the low-melting-point metal that solidifies from a molten state, in obtaining a vacuum seal structure for an image display device with use of the low-melting-point metal as the sealing material. In consequence, it is hard to manufacture a large-sized image display device that is kept at a high degree of vacuum.

### BRIEF SUMMARY OF THE INVENTION

This invention has been made in consideration of these circumstances, and its object is to provide a sealing material of improved reliability capable of maintaining a high degree of vacuum and an image display device using the same.

In order to achieve the object, according to an aspect of the invention, there is provided a sealing material used in a vacuum seal portion of an image display device, the sealing material having a melting point of 400° C. or less and a rate of contraction during solidification ranging from +0.5% to −2.5%.

According to another aspect of the invention, there is provided a flat image display device comprising two substrates located opposite each other with a gap therebetween and a vacuum seal portion which seals a predetermined position on the substrates and defines a sealed space, the vacuum seal portion having a sealing material which is filled along the predetermined position and has a melting point of 400° C. or less and a rate of contraction during solidification ranging from +0.5% to −2.5%.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view showing a field emission display (hereinafter referred to as an FED) according to a first embodiment of this invention; and

FIG. 2 is a perspective view of the FED cut away along line II-II of FIG. 1.

### DETAILED DESCRIPTION OF THE INVENTION

An embodiment in which a flat image display device according to this invention is applied to an FED will now be described in detail with reference to the drawings.

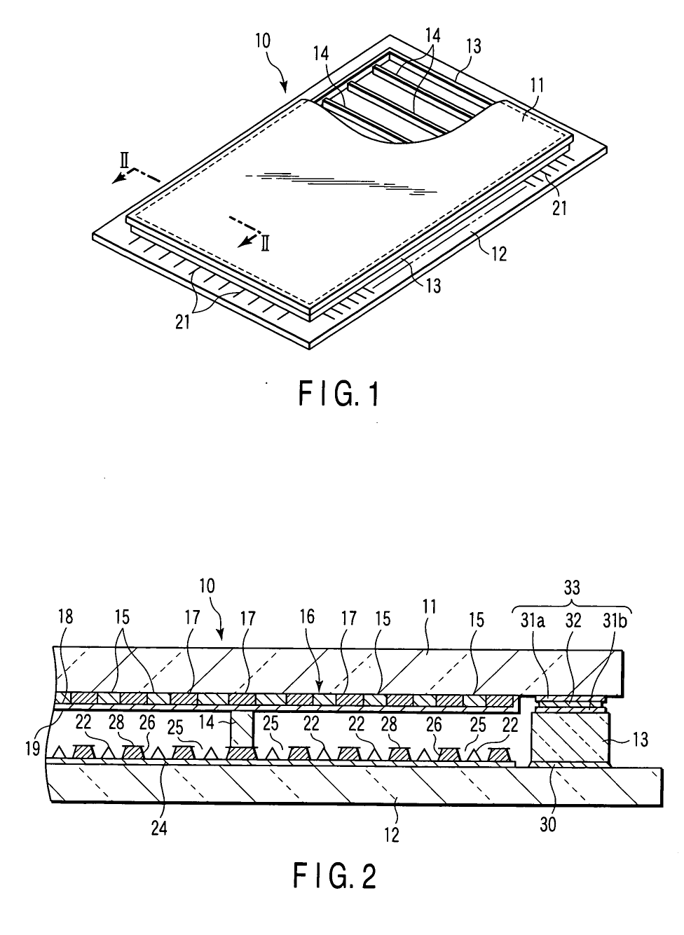

As shown in FIGS. 1 and 2, the FED comprises a first substrate 11 and a second substrate 12, which are formed of a rectangular glass substrate each. These substrates are located opposite each other with a gap of about 1.0 to 2.0 mm between them. The first substrate 11 and the second substrate 12 have their respective peripheral edge portions joined together by a spacer 13 of glass in the form of a rectangular frame, thereby forming a flat vacuum envelope 10 of which the inside is kept vacuum.

The spacer 13 that functions as a joint member is sealed to the peripheral edge portion of the inner surface of the second substrate 12 by a low-melting-point glass 30, such as fritted glass. As mentioned later, the spacer 13 is sealed to the peripheral edge portion of the inner surface of the first substrate 11 by a vacuum seal portion 33 that contains a low-melting-point metal as a sealing material. Thus, the spacer 13 and the vacuum seal portion 33 airtightly join together the respective peripheral edge portions of the first substrate 11 and the second substrate 12, thereby defining a sealed space between the first and second substrates.

A plurality of plate-like support members 14 of, e.g., glass are provided in the vacuum envelope 10, in order to support an atmospheric load that acts on the first substrate 11 and the second substrate 12. These support members 14 extend parallel to the short sides of the vacuum envelope 10 and are arranged at predetermined intervals along a direction parallel to the long sides. The shape of the support members 14 is not limited to this configuration, but columnar support members may be used instead.

A phosphor screen 16 that functions as a phosphor surface is formed on the inner surface of the first substrate 11. The phosphor screen 16 is provided with a plurality of phosphor layers 15, which glow red, green, and blue, individually, and a plurality of light shielding layers 17 formed between the phosphor layers. Each phosphor layer 15 is stripe-shaped, dot-shaped, or rectangular. A metal back 18 of aluminum or the like and a getter film 19 are successively formed on the phosphor screen 16.

Provided on the inner surface of the second substrate 12 are a large number of electron emitting elements 22, which individually emit electron beams as electron sources for exciting the phosphor layers 15 of the phosphor screen 16. Specifically, a conductive cathode layer 24 is formed on the inner surface of the second substrate 12, and a silicon dioxide film 26 having a large number of cavities 25 is formed on the conductive cathode layer. A gate electrode 28 of molybdenum, niobium, or the like is formed on the silicon dioxide film 26. The electron emitting elements 22 of molybdenum, cone-shaped, are provided individually in the cavities 25 on the inner surface of the second substrate 12. These electron emitting elements 22 are arranged in a plurality of columns and a plurality of rows corresponding to individual pixels. Besides, a large number of wires 21 for applying a potential to the electron emitting elements 22 are provided in a matrix on the second substrate 12, and their respective end portions are led out of the vacuum envelope 10.

In the FED constructed in this manner, a video signal is input to the electron emitting elements 22. A gate voltage of +100 V is applied in a state for the highest luminance based on the electron emitting elements 22. A voltage of +10 kV is applied to the phosphor screen 16. The size of electron beams emitted from the electron emitting elements 22 is modulated by the voltage of the gate electrode 28, and an image is displayed as the electron beams excite the phosphor layers of the phosphor screen 16 to luminescence. Since the high voltage is applied to the phosphor screen 16, high-strain-point glass is used as plate glass for the first substrate 11, second substrate 12, spacer 13, and support members 14.

The following is a detailed description of the vacuum seal portion 33 that seals a space between the first substrate 11 and the spacer 13.

As shown in FIG. 2, the vacuum seal portion 33 has a metal layer 31a, a metal layer 31b, and a sealing layer 32 of a sealing material. The metal layer 31a is in the form of a rectangular frame that extends along the peripheral edge portion of the inner surface of the first substrate. The metal layer 31b is in the form of a rectangular frame that extends along the first-substrate-side end face of the spacer 13. The sealing layer 32 is situated between the metal layers 31a and 31b. Each of the metal layers 31a and 31b is formed of a metal that has connectivity to glass and affinity to a low-melting-point metal.

The inventors hereof set properties for the sealing material used for the vacuum seal portion 33 and conducted various experiments to find materials that meet the conditions concerned. In consequence, it was found that desired conditions were able to be met by using a material of which the melting point is 400° C. or less and the rate of contraction during solidification ranges from +0.5% to −2.5%. Further, a metal consisting mainly of bismuth (Bi) was found to be suitably used as one such sealing material. Bismuth has a melting point of 271.4° C., solidification contraction rate of −3.32%, and vapor pressure of 8×10⁻⁵ Pa at 400° C. Since bismuth has the high negative solidification contraction rate, it has an advantage of being able to restrain solidification contraction satisfactorily if it is alloyed with any other material with a high solidification contraction rate. It was found, moreover, that the solidification contraction rate of an alloy ab made of a metal a and a metal b can be primarily expressed by
Sab=(Sb×ρa+(Sa×ρb−Sb×ρa)×Wa)/(ρa−(ρa−ρb)×Wa),
where S is the solidification contraction rate, ρ is density, and W is weight % in the alloy.

Also in the case of a metal that contains three or more components, the solidification contraction rate can be expressed by the ratio based on the above equation. However, the above equation is based on an assumption that the metal components are mixed, and it cannot hold if intermetallic compounds are produced by alloying such that the materials individually undergo solidification contraction. The inventors hereof selected the materials according to the above equation and evaluated the effectiveness of alloys made by the experiments.

Since bismuth has the high solidification contraction rate of −3.32%, as described above, the problem of discontinuity by the contraction of the sealing material during solidification can be avoided. If bismuth is used as a simple substance or a substance of a similar composition, however, it may possibly induce deformation of the substrates and the like owing to large expansion during solidification when it is applied to a large-sized image display device, in particular. Thus, it was found that the contraction (expansion) must be restricted to an appropriate rate by alloying bismuth. According to the present embodiment, therefore, an alloy that consists mainly of bismuth and is doped with tin and/or indium is used as the sealing material. The loadings of tin and/or indium are adjusted to 15 to 55% by weight.

The following is a detailed description of examples of the configuration of the FED.

### EXAMPLE 1

In order to form the FED, first and second substrates, each formed of a glass plate 65 cm long and 110 cm wide, were prepared, and the spacer 13 of glass in the form of a rectangular frame was bonded to the peripheral edge portion of the inner surface of one of them, e.g., the second substrate, with fritted glass. Then, Cr as a first metal layer was formed to a thickness of 0.4 μm on the upper surface of the spacer 13 and the peripheral edge portion of the inner surface of the first substrate 11, that is, in a predetermined position opposite the spacer 13, by means of a vacuum vapor deposition apparatus. Subsequently, Fe as a second metal layer was formed to a thickness of 0.4 μm. Further, Ag as a metallic protective layer was continuously formed to a thickness of 0.3 μm on the second metal layer without breaking the vacuum. Thereafter, an alloy as a sealing material composed of 55% by weight of Bi and 45% by weight of Sn was melted in a nitrogen atmosphere and spread on the metallic protective layer of Ag on the spacer 13 by using a heating iron.

A space of 100 mm was secured between the first and second substrates, and they were heat-treated in a vacuum of 5×10⁻⁶ Pa. Thereafter, the first and second substrates were adhered to each other so that the respective positions of the metal layers and the sealing material were aligned afterward in a cooling process, whereupon the Bi—Sn alloy was made continuous with the surfaces of the two substrates. In this state, the alloy was solidified by cooling, whereupon the vacuum seal portion 33 was formed, and the spacer 13 and the first substrate were airtightly sealed together.

When the vacuum sealing properties were evaluated through a previously formed measurement hole, thereafter, a leakage of 1×10⁻⁹ atm·cc/sec or less was exhibited, proving an appropriate sealing effect. Both this result and the appearance indicate that the glass substrates suffered no internal cracks attributable to metal sealing.

### EXAMPLE 2

In order to form the FED, first and second substrates, each formed of a glass plate 65 cm long and 110 cm wide, were prepared. Subsequently, a metal layer of Cr was formed to a thickness of 0.6 μm in a predetermined place where the glass substrates face each other, that is, on the peripheral edge portion of the inner surface of each glass substrate in this case, by means of the vapor deposition apparatus with use of austenitic stainless steel (SUS 304) as a vaporization source. Subsequently, Cu as a metallic protective layer was formed to a thickness of 0.4 μm on the metal layer. An alloy paste as a sealing material composed of 60% by weight of Bi and 40% by weight of Sn and containing a decomposition-volatile binder was spread to a thickness of 0.3 mm on each metallic protective layer. Then, a wire (1.5 mm in diameter) of an Fe-37 weight % Ni alloy plated with Ag was set as a spacer in the shape of a frame on the sealing material of one of the glass substrates.

A space of 100 mm was secured between the first and second substrates, and these substrates were temporarily fired in a vacuum of about 10⁻³ Pa at 130° C. for 30 minutes. Thereafter, the substrates were subjected to heating-deaeration treatment in a vacuum of 5×10⁻⁶ Pa. When 200° C. was then reached in the cooling process, the first and second substrates were pasted together in a predetermined position with the sealing material between them. Thereupon, the molten Bi—Sn alloy wetted and spread over the Fe—Ni alloy wire without a gap, owing to their good reciprocal affinity. In this state, the alloy was solidified to form the vacuum seal portion 33, whereby the first and second substrates were sealed together. When this FED was subjected to the same vacuum leak test as the one conducted for Example 1, the same result was obtained.

### EXAMPLE 3

First and second substrates, each formed of a glass plate 65 cm long and 110 cm wide, were prepared. Subsequently, a metal layer of Cr was formed to a thickness of 0.6 μm in a predetermined place where the glass substrates face each other, that is, on the peripheral edge portion of the inner surface of each glass substrate in this case, by means of the vapor deposition apparatus with use of 13 Cr steel as a vaporization source. Subsequently, Ag as a metallic protective layer was formed to a thickness of 0.4 μm on the metal layer. A Ti wire of 1.5-mm diameter coated with an alloy of 0.2-mm thickness, composed of 70% by weight of Bi and 30% by weight of In, as a sealing material, was set as a spacer on the metallic protective layer of one of the glass substrates.

The first and second substrates were kept horizontal with a space of 100 mm between them, and they were subjected to heating-deaeration treatment in a vacuum of 5×10⁻⁶ Pa. When 200° C. was reached in the cooling process, these two substrates were joined together in a predetermined position with the spacer between them. By this operation, the molten Bi—In alloy wetted and spread over the Ti wire without a gap, owing to their good reciprocal affinity. In this state, the alloy was solidified to form the vacuum seal portion, whereby the first and second substrates were sealed together. When this FED was subjected to the same vacuum leak test as the one conducted for Example 1, the same result was obtained.

### EXAMPLE 4

First and second substrates, each formed of a glass plate 65 cm long and 110 cm wide, were prepared. Subsequently, a metal layer of Ce was formed to a thickness of 0.4 μm in a predetermined place where the glass substrates face each other, that is, on the peripheral edge portion of the inner surface of each glass substrate in this case, by means of the vapor deposition apparatus with use of Ce as a vaporization source. Subsequently, Cu as a metallic protective layer was formed to a thickness of 0.4 μm on the metal layer. An alloy paste as a low-melting-point metal composed of 50% by weight of Bi and 40% by weight of Sn and containing a decomposition-volatile binder was spread to a thickness of 0.3 mm on each metallic protective layer. Then, a wire (1.5 mm in diameter) of ferritic stainless steel (SUS 410) plated with Ag was set as a spacer on the low-melting-point metal layer of one of the glass substrates.

A space of 100 mm was secured between the first and second substrates, and these substrates were temporarily fired in a vacuum of about 10⁻³ Pa at 130° C. for 30 minutes. Thereafter, the substrates were subjected to heating-deaeration treatment in a vacuum of 5×10⁻⁶ Pa. When 200° C. was then reached in the cooling process, the first and second substrates were pasted together in a predetermined position with the spacer between them. The molten Bi—Sn alloy wetted and spread over the SUS 410 wire without a gap, owing to their good reciprocal affinity. In this state, the alloy was solidified to form the vacuum seal portion, whereby the first and second substrates were sealed together. When this FED was subjected to the same vacuum leak test as the one conducted for Example 1, the same result was obtained.

According to the present embodiment and the individual Examples, as described above, a large-sized glass container that requires a high vacuum can be sealed, so that there may be obtained a sealing material of improved reliability capable of maintaining a high degree of vacuum and an image display device using the same.

The present invention is not limited directly to the embodiment described above, and its components may be embodied in modified forms without departing from the spirit of the invention. Further, various inventions may be made by suitably combining a plurality of components described in connection with the foregoing embodiment. For example, some of the components according to the foregoing embodiment may be omitted. Furthermore, components according to different embodiments may be combined as required.

In the present invention, the dimensions, materials, etc., of the spacer and other components are not limited to those of the foregoing embodiment, but may be suitably selected as required. This invention is not limited to image display devices that use electron emitting elements of the field-emission type as electron sources, but may be also applied to image display devices that use other electron sources, such as the surface-conduction type, carbon nanotubes, etc., and other flat image display devices of which the inside is kept evacuated.

What is claimed is:

1. A sealing material used in a vacuum seal portion of an image display device, the sealing material having a melting point of 400° C. or less and a rate of contraction during solidification ranging from +0.5% to −2.5%.

2. The sealing material according to claim 1, wherein the sealing material consists mainly of bismuth and is doped with tin and/or indium, of which loadings range from 15 to 55% by weight.

3. A flat image display device comprising two substrates located opposite each other with a gap therebetween and a vacuum seal portion which seals a predetermined position on the substrates and defines a sealed space, the vacuum seal portion having a sealing material which is filled along the predetermined position and has a melting point of 400° C. or less and a rate of contraction during solidification ranging from +0.5% to −2.5%.

4. The flat image display device according to claim 3, which comprises a phosphor layer provided on an inner surface of one of the substrates and a plurality of electron sources which are provided on an inner surface of the other substrate and excite the phosphor layer.
